(19) United States
(12) Patent Application Publication
(10) Pub. No.: US 2019/0368250 A1
(43) Pub. Date: Dec. 5, 2019

(54) HINGE MECHANISM

(71) Applicant: Acer Incorporated, New Taipei City (TW)

(72) Inventors: Yu-Chin HUANG, New Taipei City (TW); Wen-Neng LIAO, New Taipei City (TW)

(21) Appl. No.: 16/422,983

(22) Filed: May 25, 2019

(30) Foreign Application Priority Data
May 30, 2018 (TW) 107118491

(51) Int. Cl. E05D 11/08; G06F 1/16

(52) U.S. Cl. CPC E05D 11/08; G06F 1/1681

(57) ABSTRACT

A hinge mechanism is provided, including a fixed member, a rotary member, a hinge member, an annular member, and a hollow slider. The hinge member pivotally connects the rotary member to the fixed member and has a central axis. The annular member is disposed around the hinge member and has a depressed portion. The slider is disposed around the hinge member and located between the annular member and the rotary member. Additionally, the slider has a protrusion received in the depressed portion. When the rotary member rotates relative to the fixed member in an opening direction, the slider is forced by the rotary member to rotate relative to the annular member, so that the protrusion slides out of the depressed portion to form a first gap between the slider and the annular member along the central axis.

### CROSS REFERENCE TO RELATED APPLICATIONS

This application claims priority of Taiwan Patent Application Ser. No. 107118491, filed on May 30, 2018, the entirety of which is incorporated by reference herein.

### BACKGROUND OF THE INVENTION

### Field of the Invention

The application relates in general to a hinge mechanism, and in particular, to a hinge mechanism that can provide a high torque resistance.

### Description of the Related Art

As gaming laptop computers nowadays usually have considerable weight and large dimensions, they may need a hinge mechanism that can provide higher torque resistance to facilitate safe usage. However, it would be hard for users to open or close the laptop computer if the hinge mechanism has a high torque resistance. Therefore, it has become a challenge to design a hinge mechanism that is safe and easy to use in gaming laptop computers.

### BRIEF SUMMARY OF INVENTION

In view of the aforementioned problems, an object of the invention is to provide a hinge mechanism that includes a fixed member, a rotary member, a hinge member, an annular member, and a hollow slider. The hinge member pivotally connects the rotary member to the fixed member and has a central axis. The annular member is disposed around the hinge member and has a depressed portion. The slider is disposed around the hinge member and located between the annular member and the rotary member. Additionally, the slider has a protrusion received in the depressed portion. When the rotary member rotates relative to the fixed member in an opening direction, the slider is forced by the rotary member to rotate relative to the annular member, so that the protrusion slides out of the depressed portion to form a first gap between the slider and the annular member along the central axis.

In some embodiments, the depressed portion has a slope surface, and when the rotary member forces the slider to rotate relative to the annular member, the protrusion slides out of the depressed portion along the slope surface.

In some embodiments, the width of the depressed portion is greater than the width of the protrusion.

In some embodiments, the annular member has a non-circular through hole, and the hinge member is disposed through the non-circular through hole to restrict the annular member from rotating relative to the hinge member.

In some embodiments, the hinge mechanism further includes a connection member disposed around the hinge member and connected to the rotary member, wherein the connection member has a protruding portion, and the slider has a recess accommodating the protruding portion.

In some embodiments, the recess has a slope surface, and when the rotary member rotates relative to the fixed member in a direction opposite to the opening direction, the connection member is forced by the rotary member to rotate relative to the slider, and the protruding portion slides along the slope surface, to form a second gap between the connection member and the slider along the central axis.

In some embodiments, the hinge mechanism further includes at least a torque resistance element and a securing member, wherein the torque resistance element is disposed between the securing member and the annular member, and the securing member is affixed to the hinge member to restrict the torque resistance element in a predetermined position of the central axis.

In some embodiments, when the rotary member rotates relative to the fixed member in the opening direction at an included angle between the rotary member and the fixed member of less than 90 degrees, the torque resistance element generates an initial torque resistance, and when the rotary member rotates relative to the fixed member in the opening direction at an included angle between the rotary member and the fixed member of more than 90 degrees, the torque resistance element generates a first torque resistance that is greater than the initial torque resistance.

In some embodiments, when the rotary member rotates relative to the fixed member in the opposite direction from the opening direction at an included angle between the rotary member and the fixed member of more than 90 degrees, the connection member forces the slider to rotate around the central axis, and the protruding portion slides along the slope surface of the recess to form the second gap, whereby the torque resistance element generates a second torque resistance that is greater than the first torque resistance.

In some embodiments, when the rotary member rotates relative to the fixed member in the opposite direction from the opening direction at an included angle between the rotary member and the fixed member of 90 degrees, the connection member forces the slider to rotate around the central axis, so that the protrusion of the slider slides into the depressed portion, whereby the torque resistance element generates a third torque resistance which is less than the second torque resistance.

### BRIEF DESCRIPTION OF DRAWINGS

The invention can be more fully understood by reading the subsequent detailed description and examples with references made to the accompanying drawings, wherein:

FIGS. 1 and 2 shows exploded diagrams of a hinge mechanism 1 in accordance with an embodiment of the invention.

FIG. 3 is a perspective diagram of the connection member 40 shown n FIGS. 1-2.

FIGS. 4 and 5 are perspective diagrams of the slider 50 shown in FIGS. 1-2.

FIG. 6 is a perspective diagram of the annular member 60 shown in FIGS. 1-2.

FIGS. 7 and 9 are perspective diagrams showing the rotary member 20 located at 0 degrees relative to the fixed member 10, and FIGS. 8 and 10 are enlarged views of the portions A1 and A2 in FIGS. 7 and 9.

FIGS. 11 and 13 are perspective diagrams showing the rotary member 20 located at 90 degrees relative to the fixed member 10, and FIGS. 12 and 14 are enlarged views of the portions A3 and A4 in FIGS. 11 and 13.

FIGS. 15 and 17 are perspective diagrams showing the rotary member 20 located at 140 degrees relative to the fixed member 10, and FIGS. 16 and 18 are enlarged views of the portions A5 and A6 in FIGS. 15 and 17.

FIGS. 19 and 21 are perspective diagrams showing the rotary member 20 rotates a small angle relative to the fixed member 10 in a closing direction from the state of FIGS. 15 and 17, and FIGS. 20 and 22 are enlarged views of the portions A7 and A8 in FIGS. 19 and 21.

FIGS. 23 and 25 are perspective diagrams showing the rotary member 20 rotates in the closing direction from the state of FIGS. 19 and 21 to 90 degrees relative to the fixed member 10, and FIGS. 24 and 26 are enlarged views of the portions A9 and A10 in FIGS. 23 and 25.

### DETAILED DESCRIPTION OF INVENTION

The making and using of the embodiments of the hinge mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

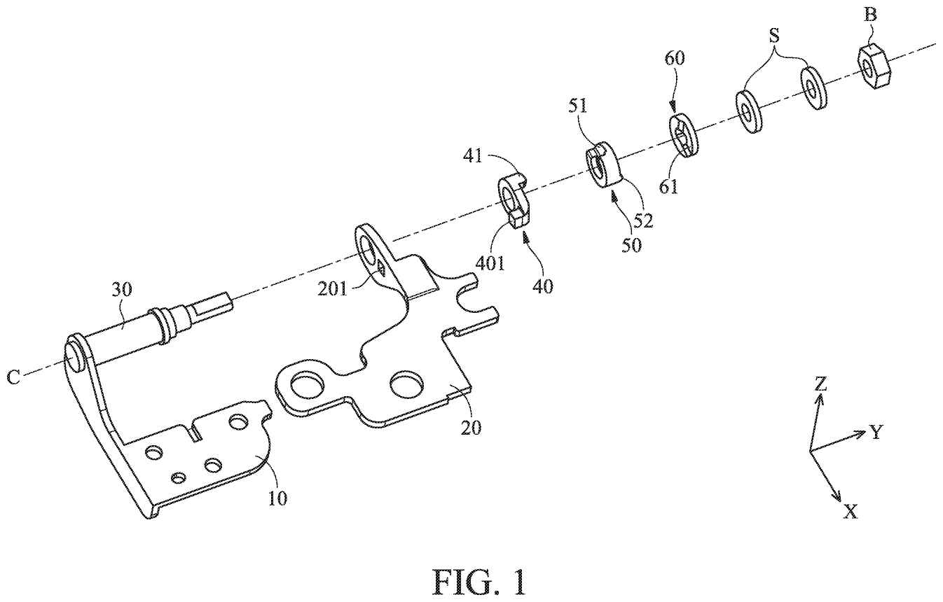

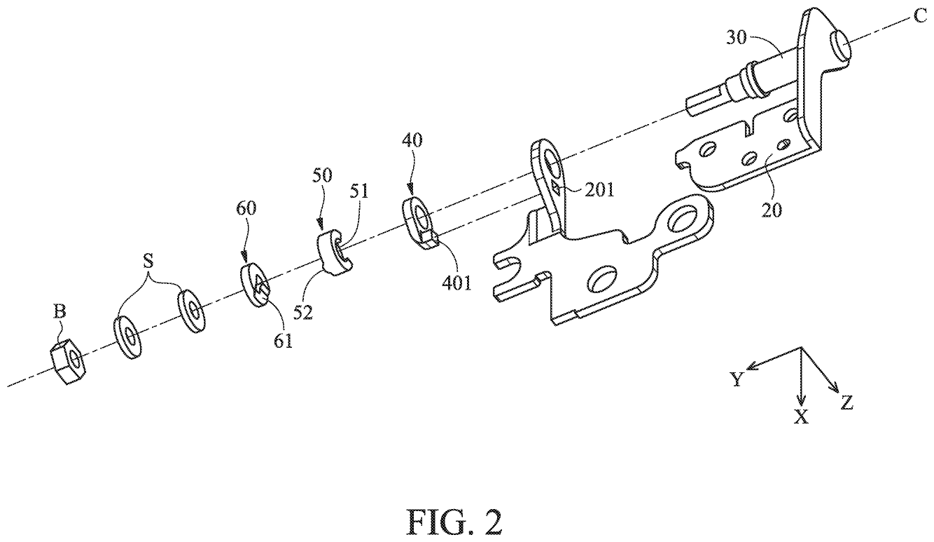

FIGS. 1 and 2 shows exploded diagrams of a hinge mechanism 1 in accordance with an embodiment of the invention. The hinge mechanism 1 may be disposed in a laptop computer, primarily comprising a fixed member 10, a rotary member 20, a hinge member 30, a connection member 40, a hollow slider 50, a annular member 60, at least a torque resistance element S, and a securing member B.

In this embodiment, the fixed member 10 may be mounted to a display unit of a laptop computer, and correspondingly, the rotary member 20 may be mounted to an input unit of the laptop computer. As the hinge member 30 extends through the fixed member 10 and the rotary member 20, the display and input units of the laptop computer can be pivotally connected to each other.

Still referring to FIGS. 1 and 2, the hinge member 30 sequentially extends through the fixed member 10, the rotary member 20, the connection member 40, the slider 50, the annular member 60, the torque resistance elements S, and the securing member B. The connection member 40 surrounds the hinge member 30 and connects to the rotary member 20. Specifically, the connection member 40 has a pin 401 joined in a hole 201 of the rotary member 20. Therefore, when the rotary member 20 rotates relative to the fixed member 10 around a central axis C of the hinge member 30, the connection member 40 can be driven by the rotary member 20 to rotate around the central axis C.

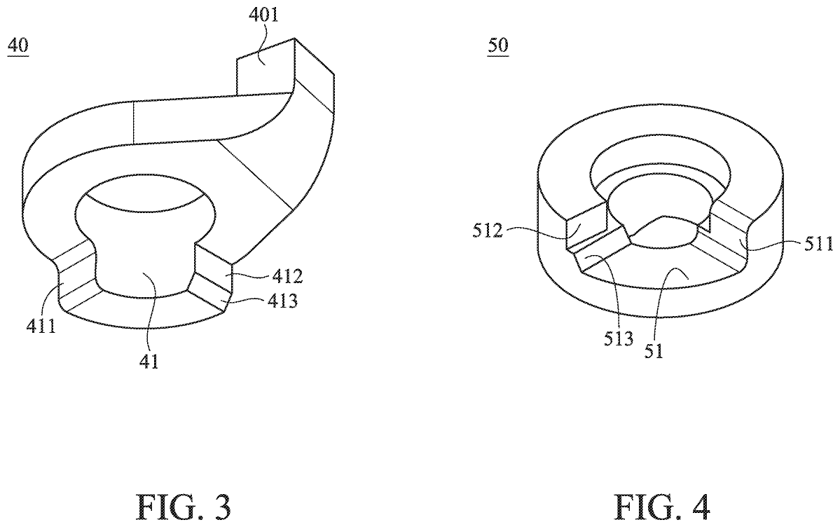

FIG. 3 is a perspective diagram of the connection member 40 shown n FIGS. 1-2, and FIGS. 4 and 5 are perspective diagrams of the slider 50 shown in FIGS. 1-2. Referring to FIGS. 1-5, the connection member 40 has a protruding portion 41 on a bottom side thereof, and the slider 50 has a recess 51 for receiving the protruding portion 41. When the rotary member 20 rotates relative to the fixed member 10 around the central axis C of the hinge member 30 in an opening direction, the slider 50 can be driven by the connection member 40 and the rotary member 20 to rotate around the central axis C.

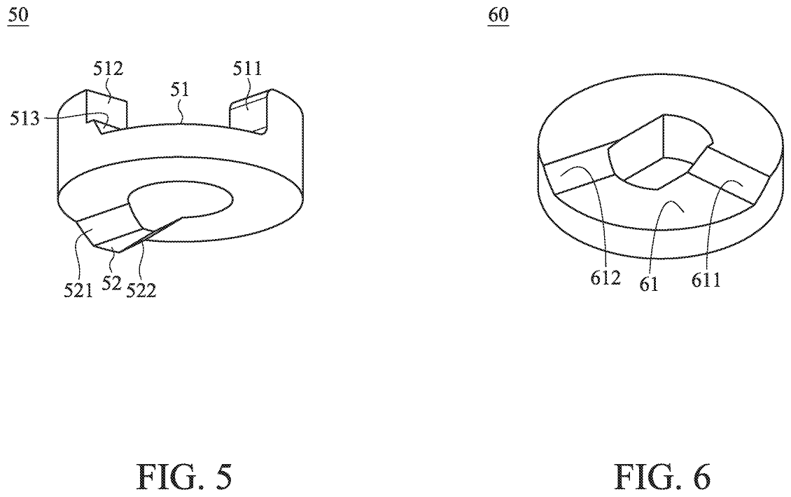

FIG. 6 is a perspective diagram of the annular member 60 shown in FIGS. 1-2. Referring to FIGS. 1-2 and 5-6, the annular member 60 in this embodiment forms a non-circular through hole with the hinge member 30 extended therethrough, so that the annular member 60 cannot rotate relative to the hinge member 30 around the central axis C of the hinge member 30. Moreover, the annular member 60 forms a depressed portion 61, and the slider 50 forms a protrusion 52 accommodated in the depressed portion 61.

Specifically, the annular member 60 further forms two slope surfaces 611 and 612 on the opposite sides of the depressed portion 61, and the width of the depressed portion 61 is greater than the width of the protrusion 52. When the slider 50 rotates relative to the annular member 60 in the opening direction to a specific angle, the protrusion 52 can slide out of the depressed portion 61.

The torque resistance elements S and the securing member B are disposed on an outer side of the annular member 60. In some embodiments, the torque resistance elements S may comprise spring sheets, metal washers, or other frictional elements, so as to provide appropriate torque resistance during the rotation of the rotary member 20 relative to the fixed member 10. The securing member B may be a nut joined with the hinge member 30 to restrict the torque resistance elements S in a predetermined position on the hinge member 30.

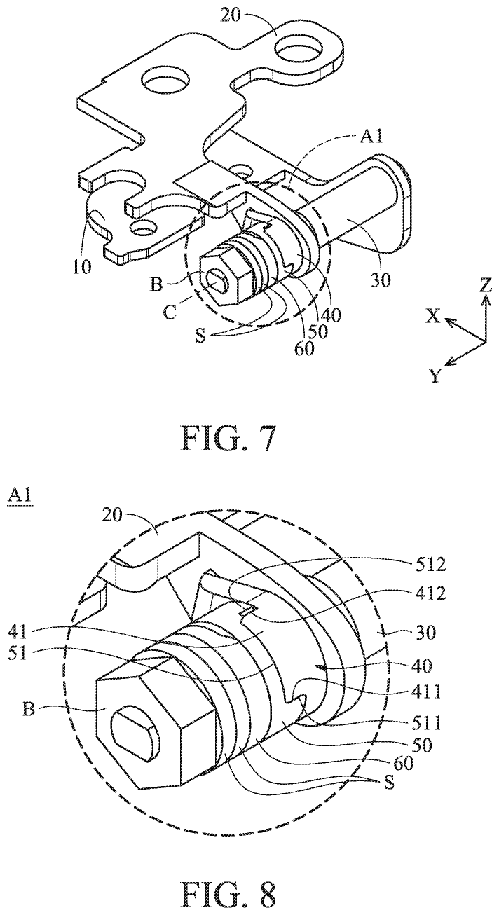

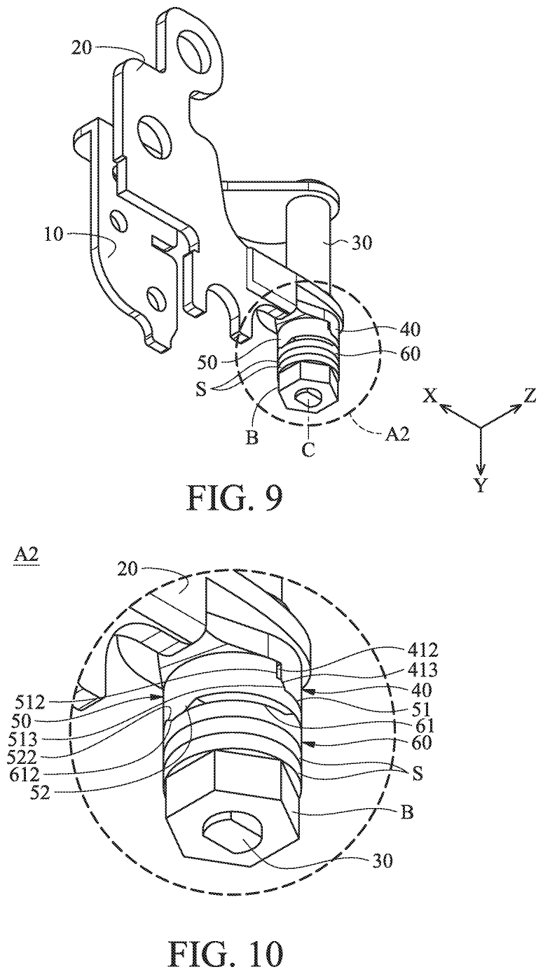

FIGS. 7 and 9 are perspective diagrams showing the rotary member 20 located at 0 degrees relative to the fixed member 10, and FIGS. 8 and 10 are enlarged views of the portions A1 and A2 in FIGS. 7 and 9. Referring to FIGS. 7 and 8, when the rotary member 20 is located at 0 degrees relative to the fixed member 10, the fixed member 10 and the rotary member 20 are both parallel to the XY plane. In this state, the protruding portion 41 of the connection member 40 is joined in the recess 51 of the slider 50 and abuts the bottom surface of the recess 51, and a sidewall 411 of the protruding portion 41 abuts an inner wall 511 of the recess 51 (FIG. 8).

Moreover, as shown in FIGS. 9 and 10, the other sidewall 412 of the protruding portion 41 (opposite to the sidewall 411) is spaced apart from the other inner wall 512 of the recess 51 (opposite to the inner wall 511). Specifically, a slope surface 513 of the recess 51 abuts a slope surface 413 of the protruding portion 41, and a slope surface 612 on the left side of the depressed portion 61 of the annular member 60 abuts a slope surface 522 of protrusion 52 (FIG. 10).

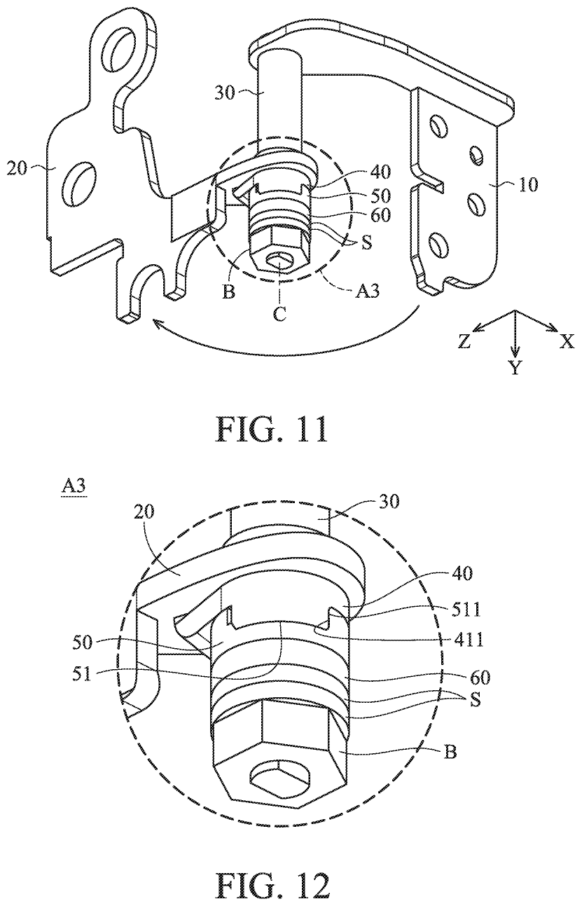

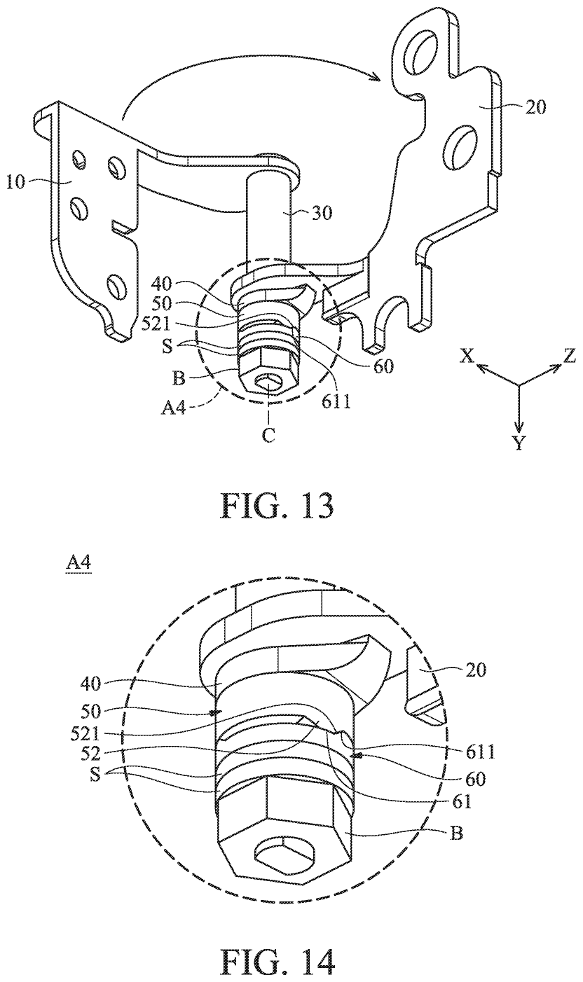

Referring to FIGS. 11-14, FIGS. 11 and 13 are perspective diagrams showing the rotary member 20 located at 90 degrees relative to the fixed member 10, and FIGS. 12 and 14 are enlarged views of the portions A3 and A4 in FIGS. 11 and 13. As the arrows indicate in FIGS. 11 and 13, when the rotary member 20 rotates relative to the fixed member 10 in an opening direction from 0 degrees (FIGS. 7 and 9) to 90 degrees, the torque resistance elements S can provide an initial torque resistance against the rotation of the rotary member 20 relative to the fixed member 10. In this state, the rotary member 20 becomes substantially parallel to the YZ plane (FIGS. 11 and 13).

During the rotation of the rotary member 20 relative to the fixed member 10 from 0 to 90 degrees, the protruding portion 41 of the connection member 40 remains in the recess 51 of the slider 50, and the sidewall 411 of the protruding portion 41 can push the slider 50 rotating around the central axis C. Furthermore, as shown in FIG. 14, the protrusion 52 of the slider 50 can slide in the depressed portion 61 of the annular member 60 to a critical position where a slope surface 521 of the protrusion 52 contacts a slope surface 611 of the depressed portion 61 (FIG. 14).

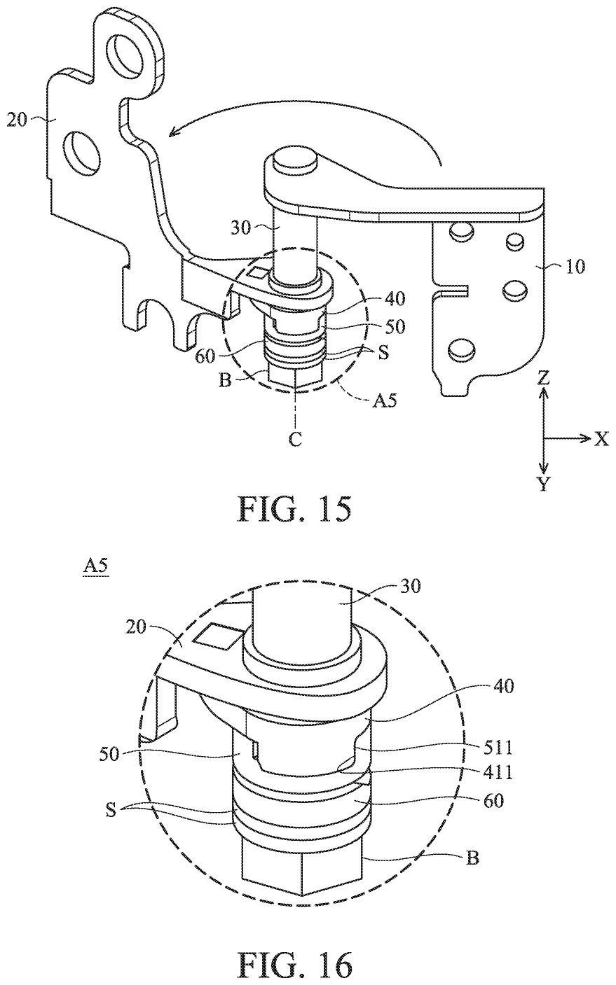

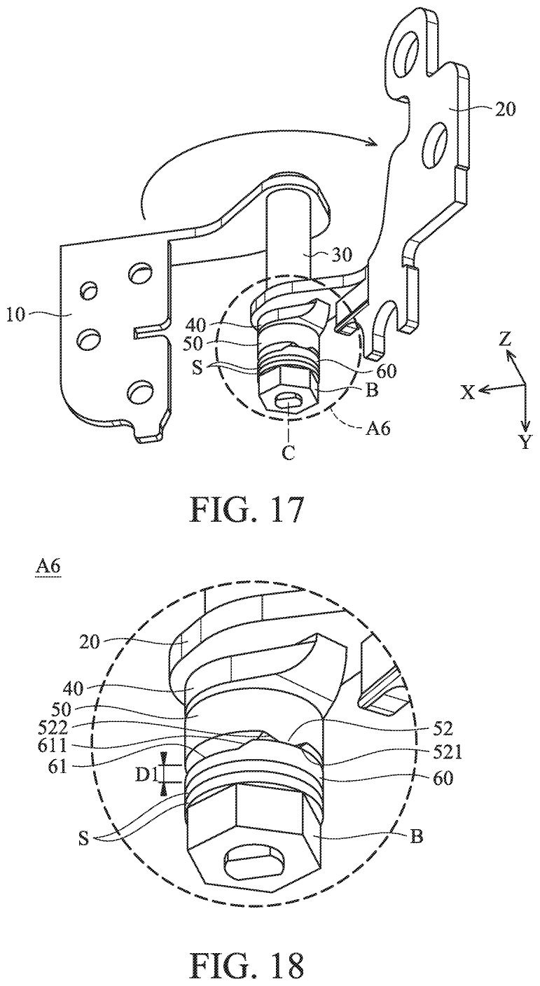

Referring to FIGS. 15-18, FIGS. 15 and 17 are perspective diagrams showing the rotary member 20 located at 140 degrees relative to the fixed member 10, and FIGS. 16 and 18 are enlarged views of the portions A5 and A6 in FIGS. 15 and 17. As the arrows indicate in FIGS. 15 and 17, when the rotary member 20 further rotates relative to the fixed member 10 in the opening direction from 90 degrees (FIGS. 11 and 13) to 140 degrees, the protruding portion 41 of the connection member 40 still remains in the recess 51 of the slider 50, and the sidewall 411 of the protruding portion 41 can force the slider 50 to rotate around the central axis C.

However, as shown in FIGS. 17 and 18, when the rotary member 20 rotates more than 90 degrees relative to the fixed member 10, the slider 50 is pushed by the connection member 40 and moves relative to the annular member 60, and the protrusion 52 of the slider 50 can slide out of the depressed portion 61 along the slope surface 611 (FIG. 18), so that a first gap D1 along the central axis C is generated between the slider 50 and the annular member 60. Hence, the torque resistance elements S are pressed and provide a first torque resistance against the rotation of the rotary member 20 relative to the fixed member 10 for the users, and the first torque resistance is higher than the initial torque resistance.

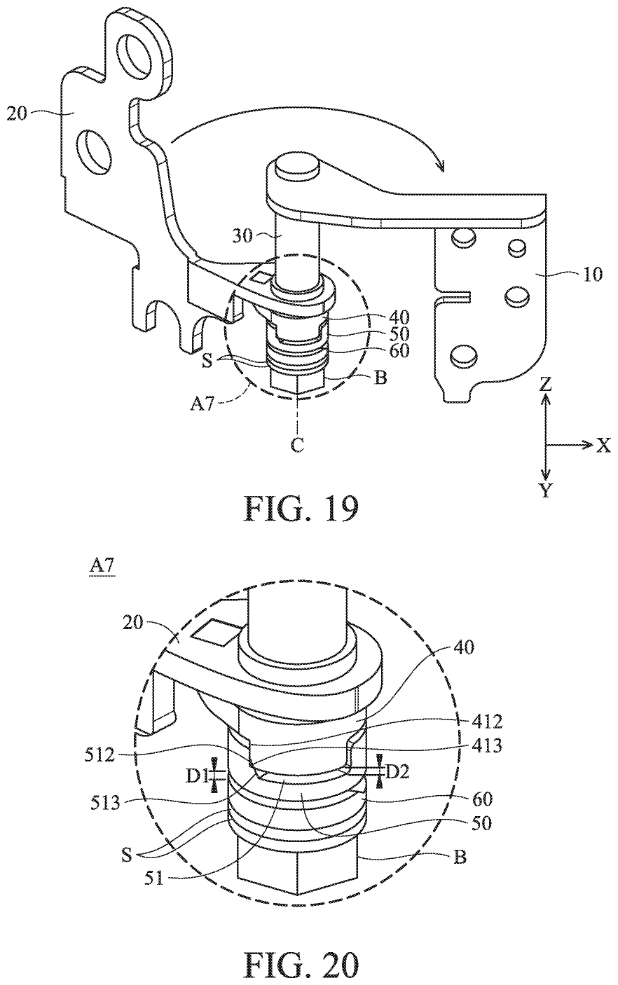

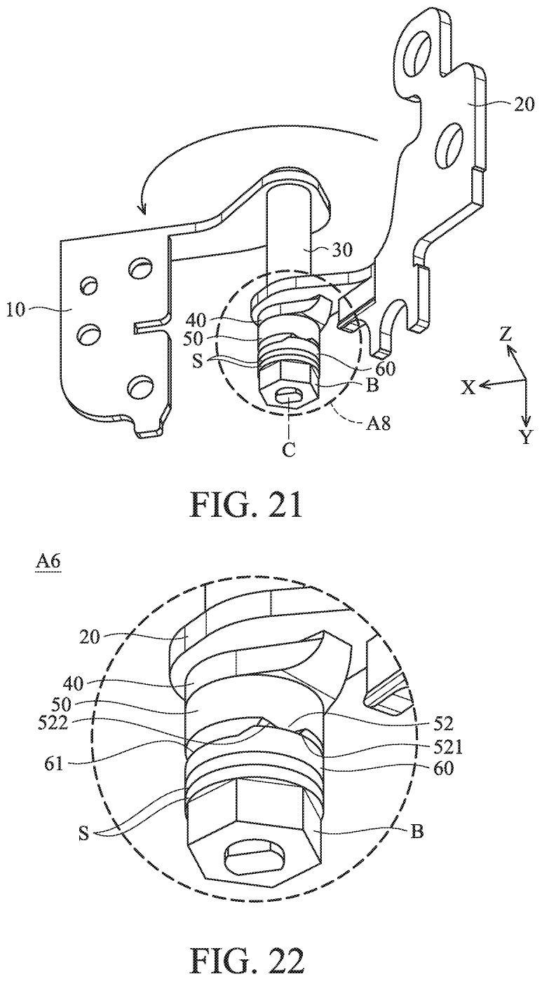

Referring to FIGS. 19-22, FIGS. 19 and 21 are perspective diagrams showing the rotary member 20 rotates a small angle relative to the fixed member 10 in a closing direction from the state of FIGS. 15 and 17, and FIGS. 20 and 22 are enlarged views of the portions A7 and A8 in FIGS. 19 and 21. As the arrows indicate in FIGS. 19 and 21, when the users reversely rotates the rotary member 20 relative to the fixed member 10 through a small angle from the state of FIGS. 15 and 17 in a closing direction (opposite to the opening direction), the rotary member 20 forces the connection member 40 to rotate around the central axis C, and the protruding portion 41 of the connection member 40 climbs over a slope surface 513 on the left side of the recess 51 to separate from the bottom of the recess 51, so that the sidewall 412 of the protruding portion 41 contacts the inner wall 512 of the recess 51 (FIG. 20).

In this state, the rotary member 20 and the fixed member 10 have an included angle of more than 90 degrees, and the slider 50 has not been forced by the connection member 40 to rotate in the closing direction, so that the protrusion 52 of the slider 50 remains outside the depressed portion 61 (FIG. 22), and the first gap D1 along the central axis C is still presented between the slider 50 and the annular member 60. It should be noted that a second gap D2 along the central axis C is generated between the connection member 40 and the slider 50 after the protruding portion 41 of the connection member 40 climbs over the slope surface 513 of the recess 51, so that the torque resistance elements S are further pressed due to the first and second gaps D1 and D2. Thus, a second torque resistance can be provided against the rotation of the rotary member 20 relative to the fixed member 10 when the users close the laptop computer, wherein the second torque resistance is higher than the first torque resistance.

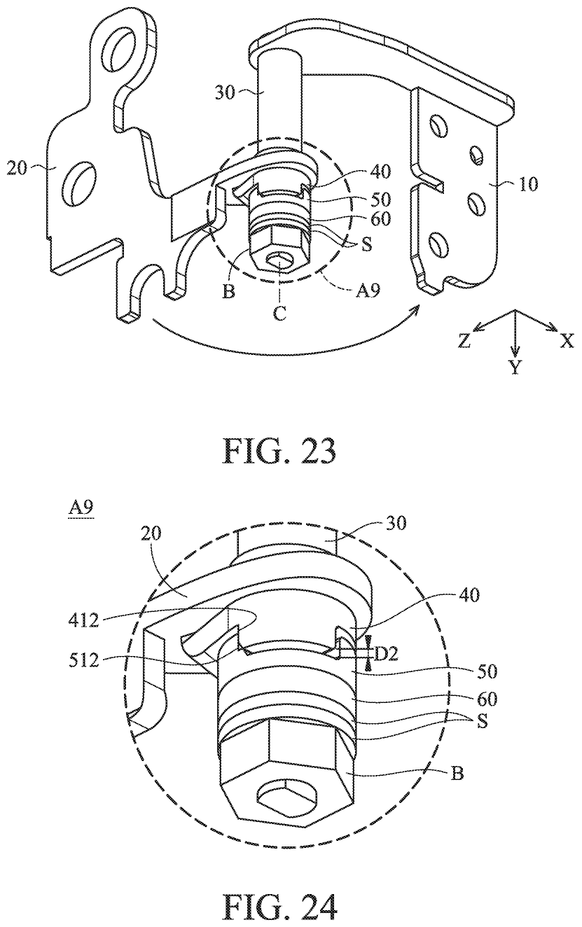

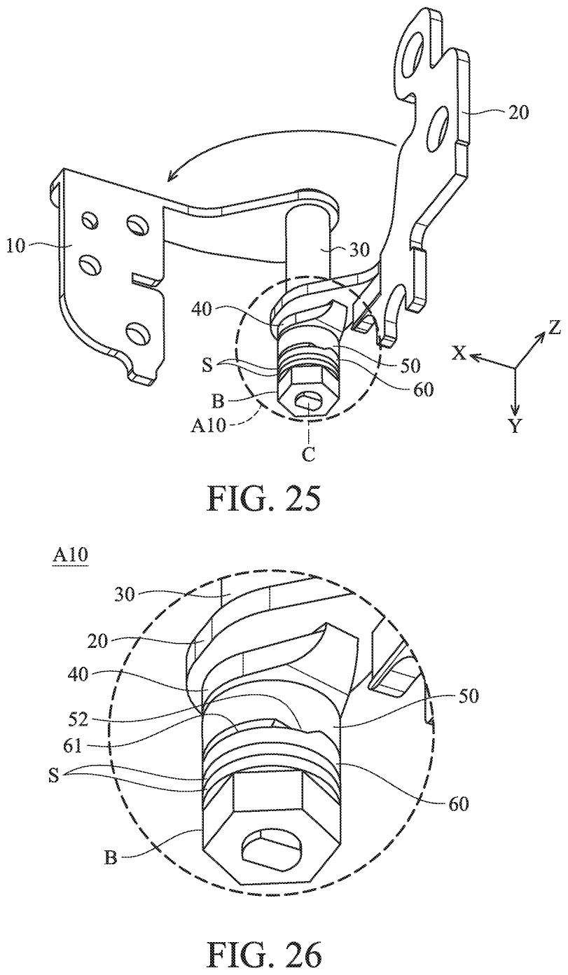

Referring to FIGS. 23-26, FIGS. 23 and 25 are perspective diagrams showing the rotary member 20 rotates in the closing direction from the state of FIGS. 19 and 21 to 90 degrees relative to the fixed member 10, and FIGS. 24 and 26 are enlarged views of the portions A9 and A10 in FIGS. 23 and 25. As the arrows indicate in FIGS. 23 and 25, when the users rotates the rotary member 20 from the state of FIGS. 19 and 21 in the closing direction (opposite to the opening direction) to 90 degrees relative to the fixed member 10, the sidewall 412 of the connection member 40 pushes the slider 50 rotating around the central axis C (FIG. 24), so that the protrusion 52 of the slider 50 slides into the depressed portion 61 via the slope surface 611 (FIG. 26).

In this state, the first gap D1 disappears, and the second gap D2 is still presented, so that the torque resistance elements S provides a third torque resistance against the rotation of the rotary member 20 relative to the fixed member 10 for the users when the rotary member 20 and the fixed member 10 have an included angle less than 90 degrees. Since the third torque resistance is less than the second torque resistance, safe and comfortable user experiences when closing the laptop computer can be achieved.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A hinge mechanism, comprising:
a fixed member;
a rotary member;
a hinge member, pivotally connecting the rotary member to the fixed member, wherein the hinge member defines a central axis;
an annular member, surrounding the hinge member and having a depressed portion; and
a hollow slider, surrounding the hinge member and located between the annular member and the rotary member;
wherein the slider has a protrusion received in the depressed portion, and when the rotary member rotates relative to the fixed member in an opening direction, the slider is forced by the rotary member to rotate relative to the annular member, so that the protrusion slides out of the depressed portion, to form a first gap between the slider and the annular member along the central axis.

2. The hinge mechanism as claimed in claim 1, wherein the depressed portion has a slope surface, and when the rotary member forces the slider to rotate relative to the annular member, the protrusion slides out of the depressed portion along the slope surface.

3. The hinge mechanism as claimed in claim 1, wherein the width of the depressed portion is greater than the width of the protrusion.

4. The hinge mechanism as claimed in claim 1, wherein the annular member has a non-circular through hole, and the hinge member is disposed through the non-circular through hole to restrict the annular member from rotating relative to the hinge member.

5. The hinge mechanism as claimed in claim 1, further comprising a connection member disposed around the hinge member and connected to the rotary member, wherein the connection member has a protruding portion, and the slider has a recess accommodating the protruding portion.

6. The hinge mechanism as claimed in claim 5, wherein the recess has a slope surface, and when the rotary member rotates relative to the fixed member in a direction opposite to the opening direction, the connection member is forced by the rotary member to rotate relative to the slider, and the protruding portion slides along the slope surface, to form a second gap between the connection member and the slider along the central axis.

7. The hinge mechanism as claimed in claim 6, further comprising at least a torque resistance element and a securing member, wherein the torque resistance element is disposed between the securing member and the annular member, and the securing member is affixed to the hinge member to restrict the torque resistance element in a predetermined position of the central axis.

8. The hinge mechanism as claimed in claim 7, wherein when the rotary member rotates relative to the fixed member in the opening direction at an included angle between the rotary member and the fixed member of less than 90 degrees, the torque resistance element generates an initial torque resistance, and when the rotary member rotates relative to the fixed member in the opening direction at an included angle between the rotary member and the fixed member of more than 90 degrees, the torque resistance element generates a first torque resistance that is greater than the initial torque resistance.

9. The hinge mechanism as claimed in claim 8, wherein when the rotary member rotates relative to the fixed member in the opposite direction from the opening direction at an included angle between the rotary member and the fixed member of more than 90 degrees, the connection member forces the slider to rotate around the central axis, and the protruding portion slides along the slope surface of the recess to form the second gap, whereby the torque resistance element generates a second torque resistance that is greater than the first torque resistance.

10. The hinge mechanism as claimed in claim 9, wherein when the rotary member rotates relative to the fixed member in the opposite direction from the opening direction at an included angle between the rotary member and the fixed member of 90 degrees, the connection member forces the slider to rotate around the central axis, so that the protrusion of the slider slides into the depressed portion, whereby the torque resistance element generates a third torque resistance which is less than the second torque resistance.
